(19) United States
(12) Patent Application Publication
(10) Pub. No.: US 2026/0134665 A1
(43) Pub. Date: May 14, 2026

(54) CAR PARTS DETECTOR

(71) Applicant: Toyota Research Institute, Inc., Los Altos, CA (US)

(72) Inventors: Kiyomasa Akaike, San Jose, CA (US); Mark E. Tjersland, Mountain View, CA (US)

(73) Assignees: Toyota Research Institute, Inc., Los Altos, CA (US); Toyota Jidosha Kabushiki Kaisha, Toyota-shi (JP)

(21) Appl. No.: 18/941,368

(22) Filed: Nov. 8, 2024

(51) Int. Cl. G06V 10/774; G06T 1/00; G06T 7/55; G06T 7/73; G06V 10/82; G06V 20/60

(52) U.S. Cl. CPC G06V 10/774; G06T 1/0014; G06T 7/55; G06T 7/73; G06V 10/82; G06V 20/60; G06T 2207/10012; G06T 2207/20081; G06T 2207/20084; G06T 2207/30108; G06V 2201/06

(57) ABSTRACT

Apparatus for detecting objects. One embodiment of an apparatus may include a first optical sensor, which may have a first field of view directed toward a target object at a first angle relative to the apparatus. The embodiment of the apparatus may include a second optical sensor, which may have a second field of view directed toward the target object at a second angle relative to the apparatus. The embodiment of the apparatus may include a processor configured to: detect a first image of the target object at the first angle; detect a second image of the target object at the second angle; infer, by a first machine learning model, depth information of the first image based on the first image and the second image; and infer, by a second machine learning model, data indicative of location of the target object based on the first image and the depth information.

### TECHNICAL FIELD

Embodiments described herein generally relate to an objects detector and, more specifically, to a car parts detector having two optical sensors and a processor configured to detect data indicative of location of an object, such as a car part.

### BACKGROUND

Current manufacturing processes, at least in part, are often automated and performed by a machine, such as a robot. Such automated manufacturing process by a machine increases manufacturing speed and/or allows a human to avoid performing a task that is excessively difficult and/or dangerous. In order for the automated manufacturing process by a machine to work properly, the machine needs to be able to detect a target object to work on. However, detecting the target object often requires an expensive equipment, such as a three-dimensional (3D) detector. The high cost of operating, maintaining, and/or replacing such expensive equipment can increase cost of the overall manufacturing process excessively. More cost-friendly equipment does not perform as well as the more expensive equipment, such as the 3D detector, in detecting the target object. When the more cost-friendly equipment fails to detect one or more target objects to work on, the manufacturing process can be disrupted, potentially resulting in undesired delays and/or failures. Accordingly, improved systems, apparatuses, and methods for detecting objects are desired.

### SUMMARY

Systems, apparatuses, and methods for detecting objects and training a machine learning model for detecting objects are described. One embodiment of a method for detecting objects includes obtaining, by a first optical sensor, a first image of a target object; obtaining, by a second optical sensor, a second image of the target object; determining, by a processor, depth information of the first image by processing the first image and the second image; and determining, by the processor, data indicative of location of the target object based on the first image and the depth information.

In another embodiment, an apparatus for detecting objects includes a first optical sensor having a first field of view configured to be directed toward a target object at a first angle relative to the apparatus; a second optical sensor having a second field of view configured to be directed toward the target object at a second angle relative to the apparatus; and a processor configured to: detect, by the first optical sensor, a first image of the target object at the first angle relative to the apparatus; detect, by the second optical sensor, a second image of the target object at the second angle relative to the apparatus; infer, by a first machine learning model, depth information of the first image based on the first image and the second image; and infer, by a second machine learning model, data indicative of location of the target object based on the first image and the depth information.

In yet another embodiment, a method for training a machine learning model for detecting objects includes generating a plurality of synthetic object images; selecting a plurality of randomized subsets of the plurality of synthetic object images; generating a plurality of first training images by adding each of the plurality of randomized subsets of the plurality of synthetic object images to a respective background image, wherein each of the plurality of first training images includes a first perspective of the respective randomized subset of the plurality of synthetic object images and the respective background image; generating a plurality of second training images associated with, respectively, the plurality of first training images, wherein each of the plurality of second training images includes a second perspective of the respective randomized subset of the plurality of synthetic object images and the respective background image; inferring, by another machine learning model, a plurality of depth information data associated with, respectively, the plurality of first training images based on the plurality of first training images and the plurality of second training images; generating a training dataset by combining first data related to a first training image of the plurality of first training images with second data related to a corresponding depth information instance of the plurality of depth information data; and training the machine learning model based on the training dataset.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in

nature and not intended to limit the disclosure. The following detailed description of the illustrative embodiments can be understood when read in conjunction with the following drawings, where like structure is indicated with like reference numerals and in which:

FIG. 1 is a block diagram illustrating an example computing environment for a car parts detector training system, according to embodiments described herein;

FIG. 2 is a block diagram illustrating an example computing environment for a car parts detector system, according to embodiments described herein;

FIG. 3 is an image depicting an example hardware configuration of an apparatus including a car parts detector system, according to embodiments described herein;

FIGS. 4A and 4B are images depicting how a training data instance may be generated for training a machine learning model of a car parts detector system, according to embodiments described herein;

FIGS. 5A and 5B are images depicting various types of data detected, generated, and/or processed by one or more components of a car parts detector system, according to embodiments described herein;

FIG. 6 is a flow chart depicting an example process for detecting objects, according to embodiments described herein;

FIG. 7 is a flow chart depicting an example process for training a machine learning model for detecting objects, according to embodiments described herein; and

FIG. 8 a block diagram illustrating computing hardware utilized in one or more devices for implementing various processes and systems, according to embodiments described herein.

### DETAILED DESCRIPTION

A general technical problem associated with automating manufacturing processes is detecting objects, such as car parts, accurately. Conventional objects detector systems often struggle to accurately locate objects in detected sensor data, such as image data. For example, detecting dark-colored, such as black, and/or shiny car parts is often a particularly challenging issue when these car parts are not accurately distinguished from their backgrounds, such as totes, boxes, containers, etc. in which the car parts are placed. For example, conventional depth sensors sometimes fail to generate accurate depth information regarding black and/or shiny surfaces or objects. One way to accurately locate objects may be to use a highly sophisticated and expensive equipment such as a 3D detector. However, adding such expensive equipment to a manufacturing process inevitably increases the cost of manufacturing due to a high cost of operating, maintaining, and/or replacing such expensive equipment. Another way to accurately locate objects may be to use a machine learning model to detect objects from detected sensor data such as image data. However, there exist technical challenges, relating to a lack of training data, in training such a machine learning model to detect objects from image data. For example, it may be impractical to use images of real car parts as training data due to privacy concerns with respect to any confidential information, such as proprietary manufacturing methods and/or designs of the real car parts. Additionally, it may be impractical to introduce any modification, such as in lighting conditions, to actual backgrounds in, for example, actual manufacturing plants in order to generate training data. The technical problems and challenges described above hinder automation of manufacturing processes. Accordingly, improved systems, apparatuses, and/or methods of detecting objects, such as car parts, and training a machine learning model for detecting objects are desired.

Embodiments of the present disclosure improve detecting objects in sensor data, such as image data corresponding to an image, by using two optical sensors and two machine learning models to infer depth information of the image and to infer data indicative of locations of objects within the image. The first optical sensor may be used to capture a first image of an object, and the second optical sensor may be used to capture a second image of the object. The first image and the second image may include different perspectives, which may also be referred to as views, of the object, which can be processed by a first machine learning model to predict, which may also be referred to as to infer, depth information of the first image and/or the second image. For example, the first machine learning model may be trained to infer depth information of an image based on images captured by the first optical sensor and the second optical sensor. The image and the depth information of the image can be processed by a second machine learning model to predict where one or more objects are within the image. For example, the second machine learning model may be trained to detect data indicative of locations of objects within an image based on the image and the depth information of the image. For example, embodiments described herein can accurately predict bounding boxes around real car parts based on an image of the real car parts and depth information of the image, even if the car parts are dark-colored or shiny. As used herein, a bounding box refers to a set of coordinates of a shaped border that fully encloses one or more objects, such as car parts, within an image. Embodiments described herein can accurately predict the bounding boxes around the real car parts in the image without using an expensive equipment such as a 3D detector. Neither of the two optical sensors used to capture image data to be used for predicting the bounding boxes is or includes a 3D detector.

Additionally, embodiments of the present disclosure overcome the technical challenges associated with the lack of training data for training a machine learning model to detect objects from image data. Embodiments of the present disclosure overcome these technical challenges by using a training method that relies on training data that is synthetically generated. The synthetically generated training data includes photorealistic data that is used to train a machine learning model to accurately predict bounding boxes around objects in an image. For example, synthetically generated training data with photorealistic backgrounds may be used to train a first machine learning model to accurately infer depth information from stereo camera images from two different perspectives. The depth information and at least a first image of the two images may be used as part of training data to train a second machine learning model to detect data indicative of locations, such as bounding boxes, of one or more objects in image data.

Embodiments of the present disclosure provide technical benefits and advance the state of the art in detecting objects for automating manufacturing processes. For example, utilizing two optical sensors, such as stereo cameras, to accurately detect objects in sensor data mitigates the risk for unwanted delays and/or failures in manufacturing processes due to undetected objects. Using two optical sensors such as stereo cameras, rather than any highly expensive 3D detector, for embodiments of the present disclosure enables accurate detection of objects in sensor data without significantly increasing associated cost. Furthermore, using synthetically generated training data for embodiments of the present disclosure enables accurate detection of objects in sensor data without exposing proprietary information regarding manufacturing methods and/or designs of real car parts.

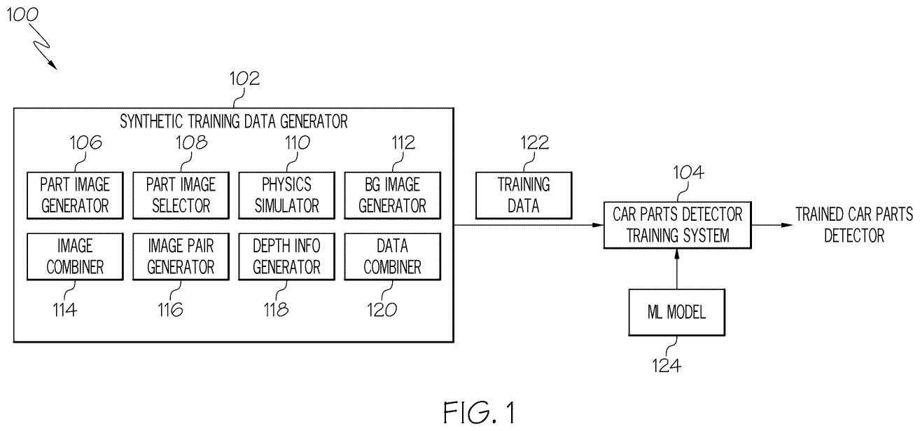

Referring now to the drawings, FIG. 1 is a block diagram illustrating an example computing environment 100 for training a car parts detector. Computing environment 100 includes synthetic training data generator 102 and car parts detector training system 104. Synthetic training data generator 102 includes part image generator 106, part image selector 108, physics simulator 110, background image generator 112, image combiner 114, image pair generator 116, depth information generator 118, and data combiner 120. Some or all of the components of synthetic training data generator 102 may be hardware or software components or modules configured to perform functionalities described herein. Synthetic training data generator 102 generates and provides training data 122, including training images, to car parts detector training system 104. Car parts detector training system 104 trains machine learning model 124 based on training data 122, to provide a trained car parts detector. Though certain components are illustrated as separate components, the functionality of such components may be combined into a single component and/or further divided among additional components.

Part image generator 106 generates a plurality of part images. In certain embodiments, part image generator 106 may be a software application program configured to automatically generate part images and/or retrieve part images from a data storage system storing part images that have already been generated. In some embodiments, part image generator 106 may be a local software application program that is implemented as part of synthetic training data generator 102. In some embodiments, part image generator 106 may be a remote service, such as a cloud-based service or a microservice, accessible by one or more application programming interfaces (APIs).

Part image generator 106 may be configured to generate any number of part images, including images of conventional parts of a device, such as a mechanical device. In certain embodiments, part image generator 106 may include or be connected to a database that stores part images. In some embodiments, part image generator 106 may be configured to receive an input, such as a user input regarding, for example, a number of part images to generate. Part image generator 106 may be configured to provide an output, such as a plurality of part images, where the number of the output part images may be based on a user input indicating a requested number of part images. In some embodiments, part image generator 106 may be configured to provide a randomized number of part images for each requested generation.

In certain embodiments, part image generator 106 does not provide or generate images of real or actual parts, such as real or actual car parts. For example, in the embodiments where part image generator 106 is a remote service, confidential information, such as proprietary manufacturing methods and/or designs of the real or actual parts, may be protected by not providing or generating images of real or actual parts. If images of real or actual parts were stored via any remote data storage system, such as if part image generator 106 is a remote service, such confidential information related to real or actual parts may be stored on the remote data storage system. Images of real or actual parts, which may be confidential information, stored on the remote data storage system may be exposed to an increased risk of disclosure of the confidential information to parties outside of a trusted group when compared to, for example, not using images of real or actual parts at all. Thus, embodiments of the present disclosure address this technical obstacle by not using images of real or actual parts and by using synthetically generated part images from part image generator 106.

In various embodiments of the present disclosure, examples of parts included in the generated part images may include, but not be limited to: a rod, a housing, a gear, a spring, a piston, a bolt, a screw, a cap, a valve, etc. In some embodiments, various properties related to the part images may be randomized. For example, the randomized properties related to the part images may include, but not be limited to: a number of the part images, sizes such as relative sizes of the parts of the part images, colors of the parts of the part images, etc. In certain embodiments, only one of these properties may be randomized. In some embodiments, various combinations of these properties may be randomized.

Part image selector 108 selects a subset of the part images generated by part image generator 106. In certain embodiments, selection of the subset of the part images may be randomized, such that the selected subset of the part images may be varied with respect to various combinations of relevant properties related to the part images, such as the number of the part images, the sizes of the parts of the part images, the colors of the parts of the part images, etc. In some embodiments, selection of the subset of the part images generated by part image generator 106 may include retrieving the subset of the part images from a data storage system that stores the part images generated by part image generator 106. In certain embodiments, the part images generated by part image generator 106 and stored via the data storage system may include metadata related to certain properties related to the part images, such as the sizes and/or the colors of the parts of the part images. The part images and the metadata may be stored as any structured data, such as JavaScript Object Notation (JSON), that associate the part images to the corresponding metadata, such that the selection of the subset of the part images can be randomized based on various properties as described above.

The selected subset of the part images may be added to an image of an enclosure, such as a tote, a box, a container, etc. in which the parts may be placed in a real or actual manufacturing environment. Thus, part image selector 108 may generate a selected image that includes an enclosure having one or more parts corresponding to the selected subset of the part images. Similar to the part images, the image of the enclosure does not include any confidential information, and may be an image of any generic or conventional enclosure.

Physics simulator 110 simulates randomization of physical properties of the parts within the enclosure of the selected image generated by part image selector 108. For example, an arrangement, such as orientations and/or locations, of the parts within the enclosure may be randomized for the selected image. In certain embodiments, certain properties such as orientation and/or size of the enclosure of the selected image may also be varied. Accordingly, physics simulator 110 may generate a simulated image that includes an enclosure having one or more parts corresponding to the selected subset of the part images from part image selector 108, where certain properties such as orientations and/or locations of the parts within the enclosure and/or certain properties such as orientation and/or size of the enclosure may be varied in a randomized manner.

Background image generator 112 generates a background image to which the simulated image from physics simulator 110 may be added. The generated background image may include a “realistic” background for the simulated image from physics simulator 110, such that the background and the enclosure having one or more parts in the simulated image from physics simulator 110 are proportionately sized. For example, the background may be any simulated space such as factory floor, laboratory, kitchen, bedroom, etc., where the relative sizes of various components within the background and of the enclosure as well as the one or more parts in the enclosure from the simulated image may be proportionate and thus realistic. In an effort to ensure that the relative sizes are realistic, background image generator 112 may obtain data related to dimensions, sizes, and/or other characteristics of the enclosure and the one or more parts in the enclosure, for example, from one or more components of synthetic training data generator 102, such as one or more of part image generator 106, part image selector 108, and/or physics simulator 110. Background image generator 112 may then generate the background image to be sized proportionately based on the obtained data. The relative sizes and/or proportions may be determined based on pre-configured proportion data or a pre-configured method of determining the relative sizes and/or proportions, which background image generator 112 may use to proportionately size various features of the background. For example, the pre-configured proportion data or the pre-configured method may define how various features of the background may be sized based on how large certain features of the background should be relative to the dimensions, sizes, and/or other characteristics of the enclosure and/or the one or more parts in the enclosure.

In certain embodiments, the generated background image may be associated with images as output from other components of synthetic training data generator 102, such as part image selector 108. As part of an illustrative example scenario, no physics simulation may be performed by physics simulator 110 on the selected image generated by part image selector 108, and the generated background image from background image generator 112 may include a background that is proportionately sized as compared to the enclosure and the one or more parts included in the selected image. Other similar variations may also be possible. As the background is configured to be proportionately sized as compared to features of the image, such as the selected image from part image selector 108 or the simulated image from physics simulator 110, that is to be added to the background image, the generated background image may be specific to and associated with the image for which it is generated. Accordingly, in certain embodiments, the generated background image may include or be associated with metadata that associates the generated background image to the image for which the background image is generated.

Image combiner 114 combines the background image generated by background image generator 112 with the simulated image from physics simulator 110 or the selected image from part image selector 108 to generate a combined image. In certain embodiments, the combined image may include the enclosure and the one or more parts in the enclosure, from the simulated image or the selected image, in the background of the background image. In some embodiments, image combiner 114 may add one or more distractors in the combined image, where the distractors may be features such as additional items to be added as distractor objects to the background. For example, the distractor objects may include a cat statute, a mouse figurine, a pot, a vase, and/or other objects that are shaped to be distinctly different from real or actual parts, such that images with such distractor objects may be used for training a machine learning to learn, for example, what is a real or actual part to be picked up or worked on and what is not.

Image pair generator 116 generates an additional image associated with the combined image generated by image combiner 114. The additional image may include the same background and the same enclosure with the same one or more parts as the combined image, but at a different perspective than that of the combined image. Accordingly, the combined image from image combiner 114 and the additional image generated by image pair generator 116 may form an image pair showing two different perspectives of the same background and the same enclosure with the same one or more parts. In certain embodiments, the combined image and the additional image, along with, for example, details regarding the difference in perspective between the two images, such as a distance between two (e.g., simulated) sensing devices that would correspond to the respective perspectives of the two images, etc. may be used by depth information generator 118 for generating depth information based on the two images.

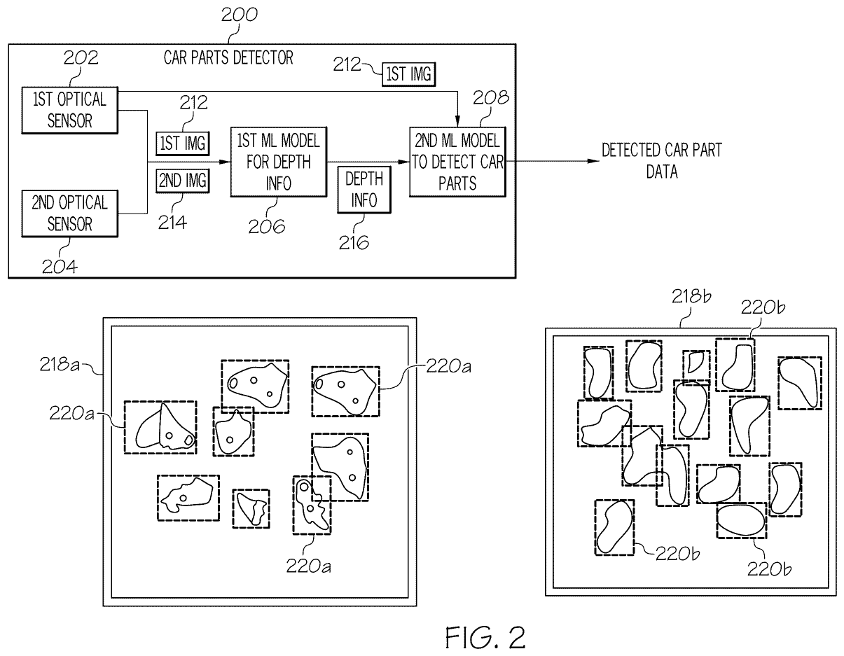

Depth information generator 118 generates depth information associated with the combined image from image combiner 114. For example, the depth information may include depth data associated with the background and the enclosure with the one or more parts of the combined image. In certain embodiments, the depth data may include numerical data of a third dimension related to the combined image which is two-dimensional (2D). For example, the depth data may include numerical values corresponding to relative depths of various features or parts of the combined image, as determined based on the combined image and the additional image of the image pair described above with respect to image pair generator 116. For example, the depth data may include a numerical value representing a relative depth of each pixel of an image, where, for example, a first pixel of an object in the image may be at a relative depth of 5 and a second pixel of a background feature in the image may be at a relative depth of 10. Such relative depths may indicate relative depths of the object and the background feature, where the higher number related to the background feature may indicate that the background feature is behind the object in the image. In some embodiments, these values may be inferred or predicted by a machine learning model, such as first machine learning model 206 described herein with respect to FIG. 2. In certain embodiments, if details regarding the difference in perspective between the combined image and the additional image described above are available, the relative depths may be calculated or determined mathematically. The generated depth information including the depth data described above may aid certain features of the combined image, such as the one or more parts within the enclosure, to be distinguished from the other parts of the combined image.

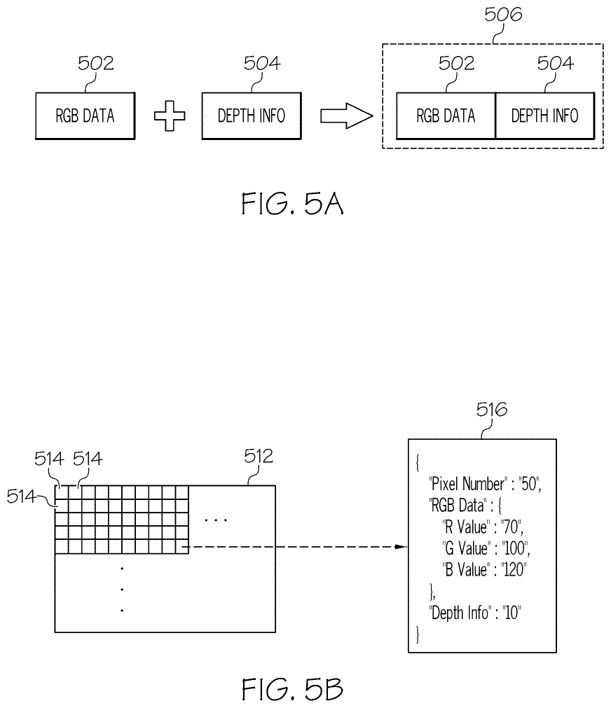

Data combiner 120 combines first data corresponding to the combined image from image combiner 114 with second data corresponding to depth information from depth information generator 118, to generate combined data to be used as part of training data 122. In certain embodiments, the first data may include numerical data corresponding to colors of various portions of the combined image, such as RGB data. The second data may include numerical data corresponding to the relative depths associated with various portions of the combined image. Additional details regarding the combined data and training data 122 are described with respect to, for example, FIGS. 5A and 5B. As described further with respect to FIGS. 5A and 5B, the combined data and training data 122 may be in the form of any structured data, such as JSON. For example, training data 122 may be stored in the form of key and value pairs, including RGB data and depth information associated with various portions of the combined image.

In certain embodiments, the combined data may be “labeled” with correct data indicative of locations of the one or more parts within the combined image, such as correct bounding boxes around the one or more parts to be detected from the combined data. In some embodiments, an operator, such as a subject matter expert, familiar with the one or more parts may identify where the correct bounding boxes should be within the combined image. The locations of, such as coordinate data corresponding to, the correct bounding boxes, which may be used as part of training data 122 for training machine learning model 124, may be referred to as labels. In certain embodiments, these labels may be used as part of training data 122 for performing a supervised training of machine learning model 124 based on training data 122 including the combined data from data combiner 120 and the labels corresponding to the correct bounding boxes. Car parts detector training system 104, including a machine learning model training logic, may train machine learning model 124 based on training data 122 to provide a trained machine learning model to be used as part of a car parts detector. In some embodiments, the supervised training of machine learning model 124 may include optimizing a plurality of weights of a mathematical loss function related to comparing, for example, bounding boxes predicted by machine learning model 124 based on training data 122 against the labeled training data. As training data 122 includes training images that are synthetically generated to be realistic, such training images of training data 122 may be referred to as ground truth images.

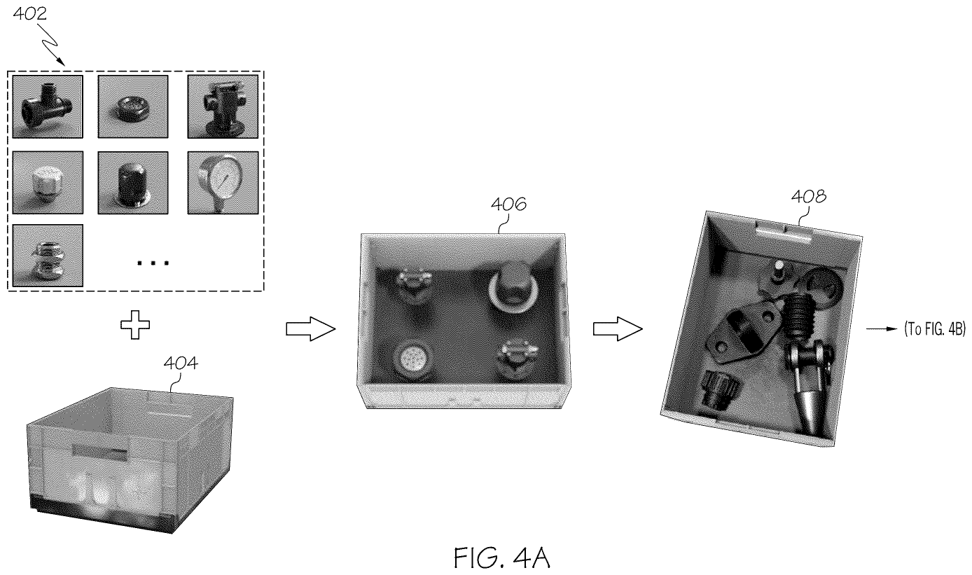

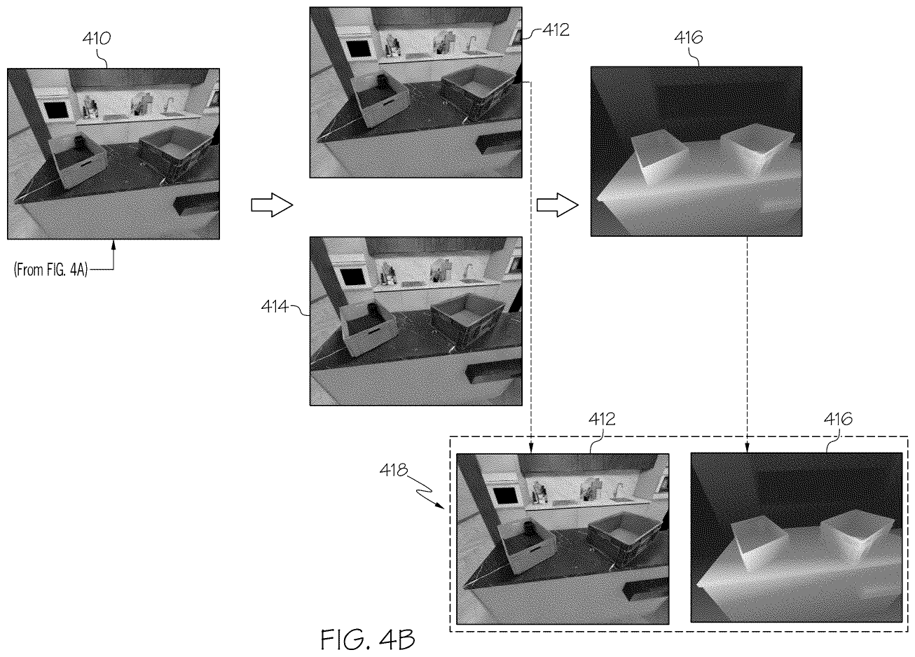

Additional details regarding generation of synthetic training data, such as training data 122, are described with respect to FIGS. 4A, 4B, 5A, and 5B.

FIG. 2 is a block diagram illustrating an example computing environment for a car parts detector. As depicted, car parts detector 200 includes first optical sensor 202, second optical sensor 204, first machine learning model 206 for determining depth information, and second machine learning model 208 for detecting car parts. In some embodiments, each of first machine learning model 206 and second machine learning model 208 may include a neural network. In certain embodiments, each of first machine learning model 206 and second machine learning model 208 may be or include a vision model that can process one or more images as part of a prompt.

In certain embodiments, first optical sensor 202 and second optical sensor 204 may each be an optical sensor configured to detect optical data. For example, each of first optical sensor 202 and second optical sensor 204 may be a camera, such as a stereo camera. Each of first optical sensor 202 and second optical sensor 204 may be any optical sensor that can detect 2D information, such as 2D images. Neither first optical sensor 202 nor second optical sensor 204 may be a 3D detector or any other highly priced and sophisticated detector configured to detect 3D data. As described herein, using two stereo cameras, rather than any expensive and sophisticated 3D detector, as first optical sensor 202 and second optical sensor 204 provides a benefit of reducing manufacturing cost for products such as cars, and provides an improvement to the state of the art for automation of manufacturing processes by enabling accurate detection of parts without using expensive equipment such as a 3D detector. Such improvement results in a technical benefit of reducing undesired delays and/or failures in automated manufacturing processes without significantly increasing cost, when compared to conventional methods that utilize a 3D detector or other detector(s) that do not detect parts as accurately as the embodiments of the present disclosure.

First optical sensor 202 captures and provides first image 212 of one or more car parts, and second optical sensor 204 captures and provides second image 214 of the one or more car parts. For example, first optical sensor 202 and second optical sensor 204 may be configured such that first optical sensor 202 captures a first perspective of the one or more car parts in first image 212 and second optical sensor 204 captures a second perspective, different from the first perspective, of the one or more car parts in second image 214. First image 212 and second image 214 may be provided to first machine learning model 206 as part of a prompt to predict depth information 216 of first image 212. While FIG. 2 depicts first image 212 as being provided to second machine learning model 208, where depth information 216 may include depth data related to first image 212, it would be apparent to one of ordinary skill in the art that second image 214 may be provided to second machine learning model 208 as part of a prompt for detecting car parts, where depth information 216 may be depth information including depth data related to second image 214. In some embodiments, first image 212 and second image 214 may be used together as part of a prompt for second machine learning model 208. For example, in an example scenario of first image 212 and second image 214 being used together as part of a prompt for second machine learning model 208, each depth information instance of depth information 216 may include an average of corresponding depth values predicted for first image 212 and predicted for second image 214.

In some embodiments, first machine learning model 206 may be a pre-trained machine learning model for determining depth information 216 of first image 212 and/or second image 214 based on first image 212 and second image 214. In certain embodiments, the combined image from image combiner 114 of FIG. 1 and the additional image from image pair generator 116 of FIG. 1 may be used as training data for training first machine learning model 206. In some embodiments, the depth information from depth information generator 118 of FIG. 1 may be used as labeled data for performing a supervised training for first machine learning model 206. The supervised training for first machine learning model 206 may include optimizing weights associated with a mathematical loss function related to comparing predicted depth information, for example, of the combined image from image combiner 114 based on the combined image from image combiner 114 and the additional image from image pair generator 116 against the depth information from depth information generator 118. Thus, first machine learning model 206 may be a pre-trained machine learning model with frozen parameters, configured to predict depth information based on two images having two different perspectives of one or more parts. Accordingly, first machine learning model 206 may be prompted to predict depth information 216 based on a prompt including first image 212 and second image 214.

As depicted in FIG. 2, second machine learning model 208 receives first image 212 and depth information 216 as part of a prompt for predicting data indicative of locations of one or more car parts within first image 212. For example, the predicted data may correspond to bounding boxes around the one or more car parts within first image 212. Examples of the predicted bounding boxes are illustrated in first example output image 218a and second example output image 218b. The predicted data from second machine learning model 208 may correspond to bounding boxes 220a within first example output image 218a and bounding boxes 220b within second example output image 218b. In certain embodiments, second machine learning model 208 may be trained by car parts detector training system 104 as described with respect to FIG. 1.

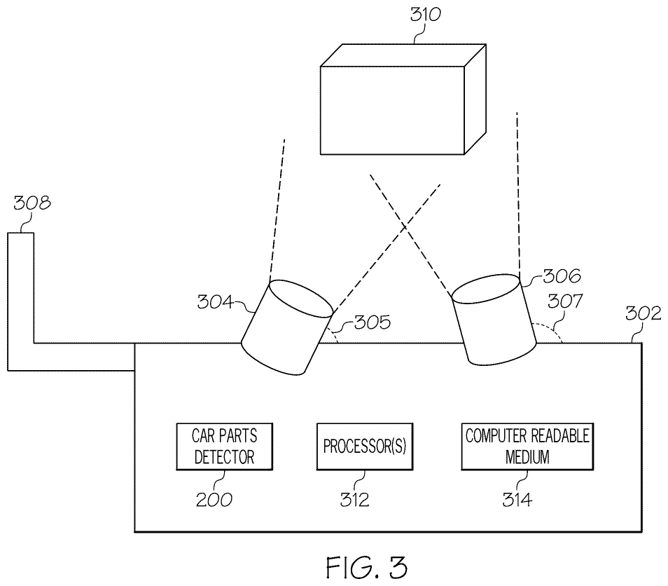

FIG. 3 is an image depicting an example hardware configuration of an apparatus including a car parts detector system. In certain embodiments, the apparatus may be a robot, such as robot 302. Robot 302 includes first optical sensor 304 and second optical sensor 306. Robot 302 includes car parts detector 200 of FIG. 2, implemented via one or more processors 312 and computer readable medium 314. First optical sensor 304 is connected to robot 302 at first angle 305 and has a first field of view, such that first optical sensor 304 may capture a first image, such as first image 212 of FIG. 2, of object 310 at a first perspective. First optical sensor 304 may correspond to first optical sensor 202 described with respect to FIG. 2. Second optical sensor 306 is connected to robot 302 at second angle 307, which is different from first angle 305, and has a second field of view, such that second optical sensor 306 may capture a second image, such as second image 214 of FIG. 2, of object 310 at a second perspective different from the first perspective. Robot 302 includes arm 308 configured to pick up or work on object 310. Robot 302 may actuate arm 308, or cause arm 308 to be actuated, to pick up or work on object 310 based on data detected via car parts detector 200, where the data detected via car parts detector 200 enables robot 302 to accurately identify object 310 as being present within the field of view of first optical sensor 304 and second optical sensor 306.

FIGS. 4A and 4B are images depicting how a training data instance may be generated for training a machine learning model of a car parts detector system. In certain embodiments, a plurality of car parts images 402 may be generated by part image generator 106 of FIG. 1. In some embodiments, part image selector 108 of FIG. 1 may select a subset of the plurality of car parts images 402 and add the subset of the plurality of car parts images 402 with enclosure image 404 to generate selected image 406. As described with respect to FIG. 1, physics simulator 110 of FIG. 1 may randomize certain physical properties associated with selected image 406 to generate simulated image 408. Then, background image generator 112 of FIG. 1 may generate a background image, and image combiner 114 of FIG. 1 may generate combined image 410 by combining simulated image 408 with the background image. Image pair generator 116 of FIG. 1 may then generate an image pair having first image 412 and second image 414, where first image 412 may correspond to combined image 410 and second image 414 may be an image that includes features of combined image 410 at a perspective, such as a second perspective, different from a perspective, such as a first perspective, of the same features in first image 412. Depth information generator 118 of FIG. 1 may generate depth image 416 by processing first image 412 and second image 414, as described with respect to FIG. 1. Then, data combiner 120 of FIG. 1 may generate combined data 418 including first data corresponding to first image 412 and second data corresponding to depth image 416. In certain embodiments, any action associated with images of FIGS. 4A and 4B, such as the plurality of car parts images 402, enclosure image 404, selected image 406, simulated image 408, combined image 410, first image 412, second image 414, and depth image 416, may include an action performed on digital representation of the images, such as RGB data associated with the images. In some embodiments, combined data 418 may be generated by concatenating first data associated with first image 412 with second data associated with depth image 416. In certain embodiments, combined data 418 may be training data 122 of FIG. 1, and may be used as part of a training data instance for training a machine learning model of a car parts detector system, such as machine learning model 124 of FIG. 1 or second machine learning model 208 of FIG. 2.

FIGS. 5A and 5B are images depicting various types of data detected, generated, and/or processed by one or more components of a car parts detector system, such as car parts detector 200 of FIG. 2.

As depicted in FIG. 5A, RGB data 502 and depth information 504 are combined for generation of combined data 506 that includes RGB data 502 and depth information 504. In certain embodiments, RGB data 502 may correspond to the type of data included in first image 212 and second image 214 detected by, respectively, first optical sensor 202 and second optical sensor 204, described with respect to FIG. 2. In some embodiments, depth information 504 may correspond to the type of data predicted by first machine learning model 206 to generate depth information 216, as described with respect to FIG. 2. RGB data 502 and depth information 504 may be combined for generation of combined data 506, which may be used as part of a prompt for second machine learning model 208 of FIG. 2 to predict data indicative of locations of objects from combined data 506. In certain embodiments, RGB data 502 may be concatenated with depth information 504 for generation of combined data 506. RGB data generally corresponds to a set of data for a RGB color model, including data, such as numerical data, corresponding to levels of red, green, and blue primary colors of light, which can be added to reproduce a broad array of colors.

As depicted in FIG. 5B, image 512 corresponding to combined data 506 of FIG. 5A may include a plurality of picture element units, such as a plurality of pixels 514. Each pixel 514 of image 512 may be represented by pixel object 516. In certain embodiments, pixel object 516 may be any structured data object, such as a JSON object. As depicted in FIG. 5B, in one non-limiting example, pixel object 516 includes a plurality of key and value pairs including information regarding pixel identification data such as pixel number, RGB data, and depth information. Pixel identification data of pixel object 516 may indicate which portion of image 512 pixel 514 represented by pixel object 516 corresponds to. In some embodiments, a plurality of pixel objects 516 may represent combined data 506 of FIG. 5A, corresponding to image 512 having a plurality of pixels 514. In certain embodiments, image 512, including information corresponding to combined data 506 having RGB data 502 and depth information 504, may be provided to second machine learning model 208 of FIG. 2 as part of a prompt to detect one or more objects, such as car parts, within image 512. In some embodiments, a subset of the plurality of pixel objects 516 may be determined, for example, by car parts detector 200 of FIG. 2 including second machine learning model 208, as corresponding to one or more objects, such as car parts, to be detected from image 512. The subset of the plurality of pixel objects 516 may be used to determine one or more bounding boxes around the one or more car parts detected from image 512, such that, for example, robot 302 of FIG. 3 can identify the one or more car parts to pick up or work on.

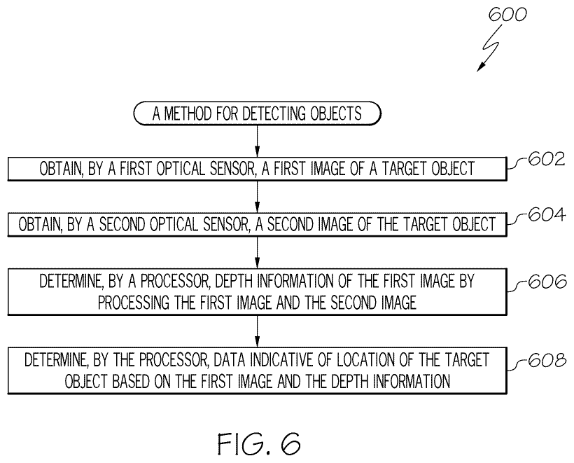

FIG. 6 is a flow chart depicting an example process, method 600, for detecting objects. In certain embodiments, method 600 can be implemented by one or more components of car parts detector 200 of FIG. 2 and/or computing device 800 of FIG. 8.

Method 600 begins, at block 602, with obtaining, by a first optical sensor, a first image of a target object. For example, the first optical sensor may be first optical sensor 202 of FIG. 2, and the first image may be first image 212 of FIG. 2. Additionally, the target object may be object 310 of FIG. 3.

Method 600 proceeds, at block 604, with obtaining, by a second optical sensor, a second image of the target object. For example, the second optical sensor may be second optical sensor 204 of FIG. 2, and the second image may be second image 214 of FIG. 2.

Method 600 proceeds, at block 606, with determining, by a processor, depth information of the first image by processing the first image and the second image. For example, the depth information may be depth information 216 of FIG. 2. The processor may be processor 802 of FIG. 8, and may utilize first machine learning model 206 of FIG. 2 to determine the depth information.

Method 600 proceeds, at block 608, with determining, by the processor, data indicative of location of the target object based on the first image and the depth information.

In certain embodiments, obtaining the first image may include obtaining the first image by a first stereo camera, and obtaining the second image may include obtaining the second image by a second stereo camera.

In some embodiments, obtaining the first image may include obtaining a first view of the target object at a first angle relative to an apparatus coupled to the first optical sensor and the second optical sensor, and obtaining the second image may include obtaining a second view of the target object at a second angle relative to the apparatus. For example, the apparatus may be robot 302 of FIG. 3.

In certain embodiments, determining the depth information may include inferring, by a machine learning model such as first machine learning model 206 of FIG. 2, the depth information based on the first image and the second image.

In some embodiments, determining the data indicative of the location of the target object may include inferring, by a machine learning model such as second machine learning model 208 of FIG. 2, the data indicative of the location of the target object based on the first image and the depth information. In some cases, method 600 may further include training the machine learning model based on a training dataset including a plurality of training images and a plurality of corresponding depth information data associated with, respectively, the plurality of training images. For example, the plurality of training images may include a plurality of synthetically generated ground truth images, each including one or more object images included in a background image, wherein the one or more object images and the background image are proportionately sized.

In certain embodiments, determining the data indicative of the location of the target object may include determining at least one of: a bounding box around the target object on the first image, or a set of coordinates corresponding to the target object on the first image. For example, the bounding box and the set of coordinates may correspond to, respectively, bounding boxes 220a, 220b of FIG. 2 and coordinates corresponding to bounding boxes 220a, 220b of FIG. 2.

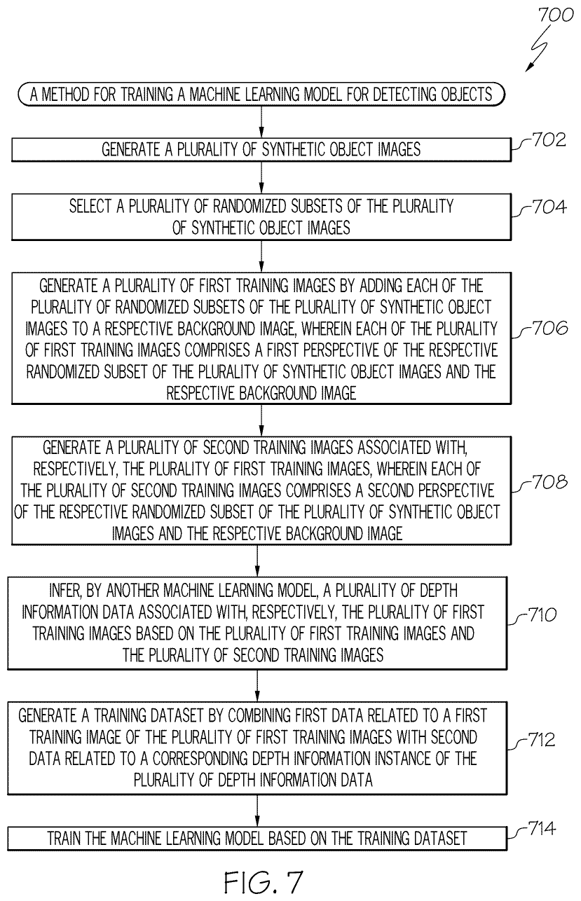

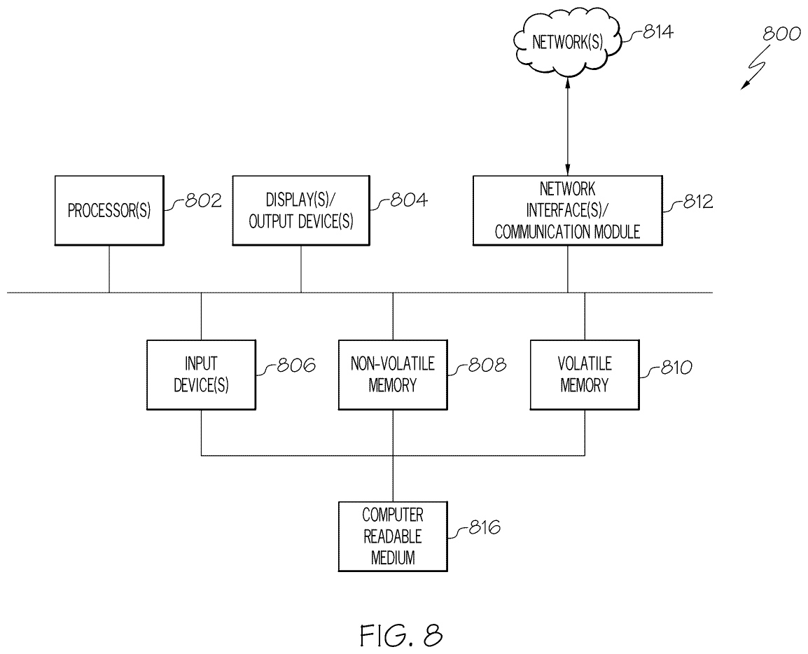

FIG. 7 is a flow chart depicting an example process, method 700, for training a machine learning model, such as second machine learning model 208 of FIG. 2, for detecting objects. In certain embodiments, method 700 can be implemented by one or more components of computing environment 100 of FIG. 1 and/or computing device 800 of FIG. 8.

Method 700 begins, at block 702, with generating a plurality of synthetic object images. For example, the plurality of synthetic object images may be a plurality of car parts images 402 of FIG. 4A.

Method 700 proceeds, at block 704, with selecting a plurality of randomized subsets of the plurality of synthetic object images. For example, the plurality of randomized subsets of the plurality of synthetic object images may be selected by part image selector 108 of FIG. 1.

Method 700 proceeds, at block 706, with generating a plurality of first training images by adding each of the plurality of randomized subsets of the plurality of synthetic object images to a respective background image, wherein each of the plurality of first training images includes a first perspective of the respective randomized subset of the plurality of synthetic object images and the respective background image. For example, a training image of the plurality of first training images may be first image 412 of FIG. 4B.

Method 700 proceeds, at block 708, with generating a plurality of second training images associated with, respectively, the plurality of first training images, wherein each of the plurality of second training images includes a second perspective of the respective randomized subset of the plurality of synthetic object images and the respective background image. For example, a training image of the plurality of second training images may be second image 414 of FIG. 4B.

Method 700 proceeds, at block 710, with inferring, by another machine learning model, a plurality of depth information data associated with, respectively, the plurality of first training images based on the plurality of first training images and the plurality of second training images. For example, a depth information data instance of the plurality of depth information data may correspond to depth image 416 of FIG. 4B, and another machine learning model of block 710 may be first machine learning model 206 of FIG. 2.

Method 700 proceeds, at block 712, with generating a training dataset by combining first data related to a first training image of the plurality of first training images with second data related to a corresponding depth information instance of the plurality of depth information data. For example, the training dataset may include training data 122 of FIG. 1, including combined data 418 of FIG. 4B.

Method 700 proceeds, at block 714, with training the machine learning model based on the training dataset.

In certain embodiments, generating the plurality of first training images may include determining an arrangement of the respective randomized subset of the plurality of synthetic object images for at least one of the plurality of first training images based on a physics simulation. For example, the physics simulation may be performed by physics simulator 110 of FIG. 1.

In some embodiments, generating the plurality of first training images may include adding one or more distractor object images to the respective background image for at least one of the plurality of first training images. For example, the one or more distractor object images may be added to the respective background image by image combiner 114 of FIG. 1.

In certain embodiments, generating the plurality of first training images may include adding the respective randomized subset of the plurality of synthetic object images for at least one of the plurality of first training images within a container image added to the respective background image. For example, the respective randomized subset of the plurality of synthetic object images may be added within the container image by part image selector 108 of FIG. 1.

In some embodiments, combining the first data with the second data may include concatenating RGB data related to the first training image with a depth value related to the corresponding depth information instance. For example, the RGB data may be concatenated with the depth value by data combiner 120 of FIG. 1.

Turning to FIG. 8, a block diagram illustrates an example of a computing device 800, through which embodiments of the disclosure can be implemented, such as (by way of non-limiting example) computing environment 100, synthetic training data generator 102, car parts detector training system 104, car parts detector 200, robot 302, and/or any other device described herein. The computing device 800 described herein is but one example of a suitable computing device and does not suggest any limitation on the scope of any embodiments presented. Nothing illustrated or described with respect to the computing device 800 should be interpreted as being required or as creating any type of dependency with respect to any element or plurality of elements. In various embodiments, a computing device 800 may include, but need not be limited to, computing environment 100, synthetic training data generator 102, car parts detector training system 104, car parts detector 200, and/or robot 302. In an embodiment, the computing device 800 includes at least one processor 802 and memory, such as non-volatile memory 808 and/or volatile memory 810. The computing device 800 can include one or more displays and/or output devices 804 such as monitors, speakers, headphones, projectors, wearable-displays, holographic displays, and/or printers, for example. The computing device 800 may further include one or more input devices 806 which can include, by way of example, any type of mouse, keyboard, disk/media drive, memory stick/thumb-drive, memory card, pen, touch-input device, biometric scanner, voice/auditory input device, motion-detector, camera, scale, etc.

The computing device 800 may include non-volatile memory 808, volatile memory 810, or a combination thereof. Examples of non-volatile memory 808 may include read only memory (ROM), flash memory, etc. Examples of volatile memory 810 may include random access memory (RAM), etc. A network interface 812 can facilitate communications over a network 814 via wires, via a wide area network, via a local area network, via a personal area network, via a cellular network, via a satellite network, etc. Suitable local area networks may support wired Ethernet and/or wireless technologies such as, for example, wireless fidelity (Wi-Fi). Suitable personal area networks may support wireless technologies such as, for example, IrDA, Bluetooth, Wireless USB, Z-Wave, ZigBee, NFC and/or other short distance communication protocols. Suitable personal area networks may similarly support wired computer buses such as, for example, USB and FireWire. Suitable cellular networks may support, but are not limited to, technologies such as LTE, WiMAX, UMTS, CDMA, and GSM. Network interface 812 can be communicatively coupled to any device capable of transmitting and/or receiving data via the network 814. Accordingly, the hardware of the network interface 812 can include a communication transceiver for sending and/or receiving any wired or wireless communication. For example, the network interface hardware may include an antenna, a modem, LAN port, Wi-Fi card, WiMax card, mobile communication hardware, short distance communication hardware, satellite communication hardware and/or any wired or wireless hardware for communicating with other networks and/or devices.

A computer readable storage medium 816 may include a plurality of computer readable mediums, each of which may be either a computer readable storage medium or a computer readable signal medium. A computer readable storage medium 816 may reside, for example, within an input device 806, non-volatile memory 808, volatile memory 810, or any combination thereof. A computer readable storage medium 816 can include tangible media that is able to store instructions associated with, or used by, a device or system. A computer readable storage medium 816 includes, by way of non-limiting examples: RAM, ROM, cache, fiber optics, EPROM/Flash memory, CD/DVD/BD-ROM, hard disk drives, solid-state storage, optical or magnetic storage devices, diskettes, electrical connections having a wire, or any combination thereof. A computer readable storage medium 816 may also include, for example, a system or device that is of a magnetic, optical, semiconductor, or electronic type. Computer readable storage mediums and computer readable signal mediums are mutually exclusive. For example, robot 302 and/or a server may utilize a computer readable storage medium to store data received from first optical sensor 304 and second optical sensor 306 on robot 302.

A computer readable signal medium can include any type of computer readable medium that is not a computer readable storage medium and may include, for example, propagated signals taking any number of forms such as optical, electromagnetic, or a combination thereof. A computer readable signal medium may include propagated data signals containing computer readable code, for example, within a carrier wave. Computer readable storage media and computer readable signal media are mutually exclusive.

The computing device 800, such as corresponding to computing environment 100, synthetic training data generator 102, car parts detector training system 104, car parts detector 200, and/or robot 302, etc., may include one or more network interfaces 812 to facilitate communication with one or more remote devices, which may include, for example, client and/or server devices. In various embodiments, the computing device 800 may be configured to communicate over a network, such as network 814, with a server or other network computing device to transmit and receive data from optical sensors 304, 306 on robot 302. A network interface 812 may also be described as a communications module, as these terms may be used interchangeably.

As illustrated above, various embodiments for detecting objects such as car parts and for training a machine learning model to detect objects are disclosed. It would be apparent to one of ordinary skill in the art that, while certain embodiments are described with respect to detecting car parts, embodiments of the present disclosure can detect any object in any context without departing from the spirit and the scope of the present disclosure. Embodiments of the present disclosure provide technical benefits and advance the state of the art in detecting objects for automating manufacturing processes. As described herein, utilizing two optical sensors, such as stereo cameras, to accurately detect objects in sensor data mitigates the risk for unwanted delays and/or failures in manufacturing processes due to undetected objects. Using two optical sensors such as stereo cameras, rather than any highly expensive 3D detector, for embodiments of the present disclosure enables accurate detection of objects in sensor data without significantly increasing associated cost. Furthermore, using synthetically generated training data for embodiments of the present disclosure enables accurate detection of objects in sensor data without exposing proprietary information regarding manufacturing methods and/or designs of real objects or parts, such as car parts.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein includes systems, methods, and non-transitory computer-readable mediums for detecting objects such as car parts and for training a machine learning model to detect objects. It should also be understood that these embodiments are merely exemplary and are not intended to limit the scope of this disclosure.

What is claimed is:

1. An apparatus for detecting objects, comprising:
a first optical sensor having a first field of view configured to be directed toward a target object at a first angle relative to the apparatus;
a second optical sensor having a second field of view configured to be directed toward the target object at a second angle relative to the apparatus; and
a processor configured to:
detect, by the first optical sensor, a first image of the target object at the first angle relative to the apparatus;
detect, by the second optical sensor, a second image of the target object at the second angle relative to the apparatus;
infer, by a first machine learning model, depth information of the first image based on the first image and the second image; and
infer, by a second machine learning model, data indicative of location of the target object based on the first image and the depth information.

2. The apparatus of claim 1, wherein:
the first optical sensor comprises a first stereo camera; and
the second optical sensor comprises a second stereo camera.

3. The apparatus of claim 1, wherein the first machine learning model comprises a neural network that is trained based on a training dataset comprising a first set of images and a second set of images associated with, respectively, the first set of images, wherein:
each image of the first set of images comprises a first view of a corresponding object at the first angle relative to the apparatus; and
each image of the second set of images comprises a second view of the corresponding object at the second angle relative to the apparatus.

4. The apparatus of claim 1, wherein the second machine learning model comprises a neural network that is trained based on a training dataset comprising a plurality of training images and a plurality of corresponding depth information data associated with, respectively, the plurality of training images.

5. The apparatus of claim 4, wherein:
the plurality of training images comprise a plurality of synthetically generated ground truth images, each comprising one or more object images included in a background image, wherein the one or more object images and the background image are proportionately sized.

6. The apparatus of claim 1, wherein the data indicative of the location of the target object correspond to a bounding box around the target object on the first image.

7. The apparatus of claim 1, wherein the data indicative of the location of the target object comprise a set of coordinates corresponding to the target object on the first image.

8. The apparatus of claim 1, wherein the processor is further configured to cause a robot to pick up the target object based on the data indicative of the location of the target object.

9. A method for detecting objects, comprising:
obtaining, by a first optical sensor, a first image of a target object;
obtaining, by a second optical sensor, a second image of the target object;
determining, by a processor, depth information of the first image by processing the first image and the second image; and
determining, by the processor, data indicative of location of the target object based on the first image and the depth information.

10. The method of claim 9, wherein:
obtaining the first image comprises obtaining the first image by a first stereo camera; and
obtaining the second image comprises obtaining the second image by a second stereo camera.

11. The method of claim 9, wherein:
obtaining the first image comprises obtaining a first view of the target object at a first angle relative to an apparatus coupled to the first optical sensor and the second optical sensor; and
obtaining the second image comprises obtaining a second view of the target object at a second angle relative to the apparatus.

12. The method of claim 9, wherein determining the depth information comprises inferring, by a machine learning model, the depth information based on the first image and the second image.

13. The method of claim 9, wherein determining the data indicative of the location of the target object comprises inferring, by a machine learning model, the data indicative of the location of the target object based on the first image and the depth information.

14. The method of claim 13, further comprising training the machine learning model based on a training dataset comprising a plurality of training images and a plurality of corresponding depth information data associated with, respectively, the plurality of training images,
wherein the plurality of training images comprise a plurality of synthetically generated ground truth images, each comprising one or more object images included in a background image, wherein the one or more object images and the background image are proportionately sized.

15. The method of claim 9, wherein determining the data indicative of the location of the target object comprises determining at least one of:
a bounding box around the target object on the first image; or
a set of coordinates corresponding to the target object on the first image.

16. A method for training a machine learning model for detecting objects, comprising:
generating a plurality of synthetic object images;
selecting a plurality of randomized subsets of the plurality of synthetic object images;
generating a plurality of first training images by adding each of the plurality of randomized subsets of the plurality of synthetic object images to a respective background image, wherein each of the plurality of first training images comprises a first perspective of the respective randomized subset of the plurality of synthetic object images and the respective background image;
generating a plurality of second training images associated with, respectively, the plurality of first training images, wherein each of the plurality of second training images comprises a second perspective of the respective randomized subset of the plurality of synthetic object images and the respective background image;
inferring, by another machine learning model, a plurality of depth information data associated with, respectively, the plurality of first training images based on the plurality of first training images and the plurality of second training images;
generating a training dataset by combining first data related to a first training image of the plurality of first training images with second data related to a corresponding depth information instance of the plurality of depth information data; and
training the machine learning model based on the training dataset.

17. The method of claim 16, wherein generating the plurality of first training images comprises determining an arrangement of the respective randomized subset of the plurality of synthetic object images for at least one of the plurality of first training images based on a physics simulation.

18. The method of claim 16, wherein generating the plurality of first training images comprises adding one or more distractor object images to the respective background image for at least one of the plurality of first training images.

19. The method of claim 16, wherein generating the plurality of first training images comprises adding the respective randomized subset of the plurality of synthetic object images for at least one of the plurality of first training images within a container image added to the respective background image.

20. The method of claim 16, wherein combining the first data with the second data comprises concatenating RGB data related to the first training image with a depth value related to the corresponding depth information instance.
